(19) United States
(12) Patent Application Publication
(10) Pub. No.: US 2007/0071935 A1
(43) Pub. Date: Mar. 29, 2007

(54) Optical disc

(76) Inventors: Ping-Hun Lin, Jhongli City (TW); Fung-Hsu Wu, Gueishan Township (TW); Chen Peng, Taipei City (TW); Yao-Wen Chang, Fongshan City (TW)

Correspondence Address: HOFFMAN WARNICK & D'ALESSANDRO, LLC, 75 STATE STREET, 14TH FLOOR, ALBANY, NY, 12207, US

(21) Appl. No.: 11/417,956

(22) Filed: May 4, 2006

(30) Foreign Application Priority Data
Sep. 28, 2005 (TW) 094133658

(51) Int. Cl. B32B 3/02

(52) U.S. Cl. 428/64.4

(57) ABSTRACT

The present invention provides an optical disc including a substrate. The substrate has a label surface. According to the invention, an ink mixture, including a plurality of functional microcapsules, is coated on the label surface to form a coloring layer. In an embodiment, at least part of the functional microcapsules encapsulates an ultraviolet light absorbent to increase the light fastness of the coloring layer.

### BACKGROUND OF THE INVENTION

1. Field of the Invention

The present invention relates to an optical disc and, more particularly, to an optical disc whose label surface is coated with a plurality of functional microcapsules.

2. Description of the Prior Art

Optical discs are a highly popular medium for storing data in various forms such as text, graphics, audio, video . . . etc. Examples of available optical disc formats include CD-R, CD-RW, DVD-R, DVD-RW . . . etc. When optical disc technology was first introduced, only source manufacturers could program individual optical discs, and they typically did so on a mass production basis. Once formatted with the desired data, the optical discs were provided to consumers with some form of printed identification information on a non-data surface thereof. More recently, consumers have been able to “burn” the data which they want onto a “blank” optical disc. Once formatted, the user will almost certainly desire to provide some form of identification information on the non-data surface of the optical disc. In recent years, there have been several proposed techniques related to creating images on the label layer of an optical disc, such as a technique proposed in 2005 by Hewlett-Packard Development Company, LP. The technique is known as the LightScribe technique, in which a coloring layer that changes its color in response to heat or light is provided by the label layer of the optical disc. The coloring layer is set to face an optical pickup, by which a laser beam is irradiated to cause the coloring layer to change its color, so as to form a visible image. Accordingly, the optical disc can be identified through this technique.

When irradiated by laser beams, the colorant on the coloring layer will fade gradually because of photochemistry reaction. Photochemistry reaction is triggered by light energy and classified into Photolysis, Photo-synthesis, and Photo-sensitization. The traditional way to improve light fastness is to increase the fastness of the color. For instance, indigo mixed with halogens ion has more light fastness than one that is not mixed with halogens ion. As disclosed in U.S. Pat. No. 6,176,909, a water-based ultraviolet light absorbent is added into the ink to increase its light fastness. However, the colorant with better light fastness will present limited color saturation. Since photochemistry reaction is not reversible, if an ultraviolet light absorbent is directly added into an ink, it will react with light continuously until it is completely consumed. Accordingly, the ink mentioned above does not achieve the purpose of getting better light fastness. The LightScribe technique uses laser beams to irradiate the printable surface of the optical disc, so as to form a visible image on the optical disc. Even though the ultraviolet light absorbent is added onto the optical disc, it diminishes so considerably that it does not preserve the optical disc after irradiated by laser beams.

Accordingly, a scope of the invention is to provide an optical disc, wherein the label surface is coated with a layer of microcapsules including an ultraviolet light absorbent before coated with the ink so as to ensure that the optical disc has enough ultraviolet light absorbents.

In addition, another scope of the invention is to provide an optical disc, wherein a plurality of functional microcapsules are provided on the label surface. Some of the microcapsules encapsulate an ultraviolet light absorbent, and others encapsulate a special solvent, such as a volatile perfume.

### SUMMARY OF THE INVENTION

According to one preferred embodiment of the invention, an optical disk includes a substrate with a label surface and an ink mixture coated on the label surface to form a coloring layer with a plurality of functional microcapsules. In an embodiment, at least part of the functional microcapsules encapsulates an ultraviolet light absorbent. In another embodiment, at least part of the functional microcapsules encapsulates a perfume. According to another preferred embodiment of the invention, an optical disc includes a substrate with a label surface, a microcapsule mixture coated on the label surface with a plurality of functional microcapsules, and an ink mixture coated on the label surface to form a coloring layer with a plurality of functional microcapsules. In an embodiment, at least part of the functional microcapsules encapsulates an ultraviolet light absorbent. In another embodiment, at least part of the functional microcapsules encapsulates a perfume. The advantage and spirit of the invention may be understood by the following recitations.

### BRIEF DESCRIPTION OF THE APPENDED DRAWINGS

None.

### DETAILED DESCRIPTION OF THE INVENTION

The present invention provides an optical disc, and more particularly, a label surface of the optical disc which, according to the invention, is coated with a plurality of functional microcapsules.

According to one preferred embodiment of the invention, an optical disc includes a substrate with a label surface and an ink mixture coated on the label surface to form a coloring layer with a plurality of functional microcapsules.

In an embodiment, at least part of the plurality of the functional microcapsules encapsulates an ultraviolet light absorbent and is coated on the label surface to increase the light fastness of the optical disc.

The microcapsule encapsulates the surface of a solid body or a liquid micro drop with a thin wall. The size of the micro drop ranges from one micrometer to thousands of micrometers. Based on the characteristic and the usage of the product, microcapsules are likely to exist in powder format or in dispersedly emulsive format. At present, microcapsule wall are primarily formed by synthetic polymer. The representative instances are Urea-formaldehyde and Melamine-formaldehyde resins, which have high density and good water resistance. The interior content of microcapsules is not easily influenced by environment; it also effectively extends its effect, prevents oxidization, and increases its stability. In addition, the exterior membranes of the microcapsules allow the interior content to be released gradually as time elapses. Therefore, it can extend the efficacy of the entire interior content for a period of time.

The invention uses microcapsules, which are uniformly mixed with a dispersant and an emulsifier, to encapsulate the ultraviolet light absorbent. Since a variety of microcapsule wall and technique in dispersion can be applied in the invention, the ultraviolet light absorbent can be mixed with water-based ink or solvent-based ink. Through the microcapsules, the ultraviolet light absorbent is released gradually to retain light fastness of the coloring layer on the label surface of the optical disc.

The ultraviolet light absorbent that is adaptive to be encapsulated in microcapsules can be water-based, such as TINUVIN 109, TINUVIN 384-2, TINUVIN 2140, TINUVIN 5050, and TINUVIN 5151, which are produced by Ciba. Alternatively, it can be solvent-based, such as TINUVIN 328, TINUVIN 384, TINUVIN 900, TINUVIN 928, TINUVIN 1130, TINUVIN 400, TINUVIN 123, TINUVIN 144, TINUVIN 292, TINUVIN 1405, and TINUVIN 1930, also produced by Ciba; UV-1, UV-2, UV-4, produced by SUNKO; LA-77, LA-62, produced by ADEKA ARGUS, and JF-77, which is produced by JOHOKU.

In another embodiment, beside at least part of the plurality of the functional microcapsules encapsulates a volatile perfume, which makes the optical disc fragrant and has no influence on the performance of the ink. Since microcapsules can effectively control the release of the perfume, the optical disc remains fragrant for a long time. In an embodiment, beside a plurality of functional microcapsules, the ink mixture includes a colorant for exhibiting a changeable color in response to heat or light, a medium for controlling the response of the changeable color, a dispersant making a plurality of functional microcapsules disperse uniformly in the microcapsule mixture, and an emulsifier making a plurality of functional microcapsules dissolve in the medium.

What is adaptive to be an emulsifier is A-102 and LF-4, which are produced by CYTEC; 1, 3-BG, 1,3-BG, OG, BEPG, and PD-9, which are produced by KYOWA, EP-810, 2-propanol, di-1, 2-propylene glycol, 2-pyrrolidone, N-methy-2-pyrrolidone, 2,4,7,9-tetramethyl-5-decyne-4, 7-diol, or 1,1,1-trimethylolpropane, which are produced by AIR PRODUCT.

What is adaptive to be a dispersant is polyethandiol, polypropandiol, EO/PO copolymer, BO/EO copolymer, sodium dioctyl sulfonsuccinate, alkylene oxide adduct of acetylene glycol, polybutyl resin, cellulose derivative, styrene/acrylic copolymer, maleic acid/styrene copolymer, or a polymer including hydrophilic segment and hydrophobic segment.

According to another preferred embodiment of the invention, an optical disc includes a substrate with a label surface, a microcapsule mixture with a plurality of functional microcapsule coated on the label surface, and an ink mixture coated on the label surface that is already coated with the microcapsule mixture to form a coloring layer. In an embodiment, at least part of a plurality of functional microcapsules encapsulates an ultraviolet light absorbent.

ln an embodiment, at least part of a plurality of functional microcapsules encapsulates a volatile perfume.

In an embodiment, the ink mixture includes a colorant for exhibiting a changeable color in response to heat or light and a medium for controlling the response of the changeable color.

In an embodiment, the microcapsule mixture also includes a dispersant making a plurality of functional microcapsules disperse uniformly in the microcapsule mixture, and an emulsifier making a plurality of functional microcapsules dissolve in the medium. The invention provides an optical disc, wherein a plurality of functional microcapsules is coated on the label surface. Since microcapsules can protect their interior content, they retain the stability of the content and make use of the characteristic of releasing the content gradually to extend the lifespan of the interior content.

When the plurality of functional microcapsules encapsulates water-based or solvent-based ultraviolet light absorbent, the ultraviolet light absorbent is not easily influenced by environment, effectively extends its effect, and increase its stability. The ultraviolet light absorbent increases the light fastness of the optical disc to extend it for a long time and allows the optical disc to possess superior quality in printing. In addition, even though the ultraviolet light absorbent in the upper layer diminishes by reacting with the optical disc drive, it can still increase the lifespan of the optical disc. The reason is that the microcapsules can effectively control the release of the perfume so that the ultraviolet light absorbent are continuously coated on the optical disc and prolongs its effect. By the same token, when the plurality of functional microcapsules encapsulate a perfume, it can also avoid the influence of environment, effectively extend the time for preserving the perfume, and control the release of perfume to retain the fragrance of the optical disc. Meanwhile, it can make use of the characteristic of controlling the release of the perfume to be the indicator of the lifespan of the optical disc. When the perfume is completely released, the optical disc will lose its fragrance and reach its preservable period. With the explanations of the preferred embodiment above, the features and spirits of the invention will be hopefully well described, but the scope of the invention will not be constrained. However, the purpose is expected to cover diverse changes and equivalent arrangements in the scope of the patent for which the invention apply.

What is claimed is:

1. An optical disc, comprising:
a substrate having a label surface; and
an ink mixture, coated on the label surface to form a coloring layer, the ink mixture comprising a plurality of functional microcapsules.

2. The optical disc of claim 1, wherein at least one of the plurality of functional microcapsules encapsulates an ultraviolet light absorbent.

3. The optical disc of claim 1, wherein at least one of the plurality of functional microcapsules encapsulates a perfume.

4. The optical disc of claim 1, wherein the ink mixture also comprises:
a colorant for exhibiting a changeable color;
a medium for controlling the response of the changeable color;
a dispersant making the plurality of functional microcapsules disperse uniformly in the medium; and
an emulsifier making the plurality of functional microcapsules dissolve in the medium.

5. An optical disc, comprising:
a substrate having a label surface;
a microcapsule mixture, coated on the label surface, the microcapsule mixture comprising a plurality of functional microcapsules; and
an ink mixture, coated on the label surface coated with microcapsule mixture to form a coloring layer.

6. The optical disc of claim 5, wherein at least one of the plurality of functional microcapsules encapsulates an ultraviolet light absorbent.

7. The optical disc of claim 5, wherein at least one of the plurality of functional microcapsules encapsulates a perfume.

8. The optical disc of claim 5, wherein the ink mixture also comprises:
a colorant for exhibiting a changeable color; and
a medium for controlling the response of the changeable color.

9. The optical disc of claim 5, wherein the microcapsule mixture also comprises:
a dispersant making the plurality of functional microcapsules disperse uniformly in the microcapsule mixture; and
an emulsifier making the plurality of functional microcapsules dissolve in the medium.
